(19) United States
(12) Patent Application Publication
(10) Pub. No.: US 2026/0295780 A1
(43) Pub. Date: Oct. 1, 2026

(54) PICK-UP TOOL

(71) Applicant: Shun-Chieh CHIANG, Taipei City (TW)

(72) Inventor: Shun-Chieh CHIANG, Taipei City (TW)

(21) Appl. No.: 19/573,649

(22) Filed: Mar. 20, 2026

(30) Foreign Application Priority Data
Mar. 25, 2025 (TW) 114202959

(51) Int. Cl. B25B 9/02

(52) U.S. Cl. CPC B25B 9/02

(57) ABSTRACT

A pick-up tool for picking up a floor drain assembly includes a main body that is integrally formed and that has a stationary portion having a top end and a bottom end, two operation portions, two hook portions, and an auxiliary portion. Each operation portion has a top edge and a bottom edge opposite to each other, and a connection region. For each operation portion, the connection region extends from the top edge in a direction away from the top end and is spaced apart from the connection region of another operation portion. Each hook portion is connected to the bottom edge of a respective operation portion. Each hook portion and the connection region of the respective operation portion form an included angle therebetween. The auxiliary portion extends from the top end, and has a thickness gradually decreasing in a direction away from the bottom end.

### CROSS-REFERENCE TO RELATED APPLICATION

This application claims priority to Taiwanese Utility Model Patent Application No. 114202959, filed on Mar. 25, 2025, the entire disclosure of which is incorporated by reference herein.

### FIELD

The disclosure relates to a pick-up tool, and more particularly to a pick-up tool for picking up a floor drain assembly.

### BACKGROUND

Generally, a drain pipe is buried underground and extends upward to the ground surface to form an inlet. The inlet is typically covered by a floor drain grate featuring multiple spaced-apart perforations, serving to preliminarily filter hair, dust, skin flakes, debris and dirt carried by water that flows into the inlet. A floor drain set is usually mounted to the inlet of the drain pipe, which serves to further filter the debris and dirt that bypass the floor drain grate and enter the inlet, thereby preventing accumulation of a large amount of debris and dirt in the drain pipe within a short period of time (which reduce the flow rate). While the floor drain grate provides initial filtration and the floor drain set further filters debris and dirt, it is well-known that excessive accumulation of debris and dirt on the floor drain grate or within the floor drain set will impair the flow rate of water entering the drain pipe. Moreover, debris and dirt accumulating in the floor drain set may foster mold harmful to human health. To prevent these from happening, both the floor drain grate and floor drain set should be regularly cleaned.

When the floor drain grate and the floor drain set are to be cleaned, a flathead screwdriver is usually used to pry and remove them from the drain pipe. Then, a user may sequentially place the floor drain grate and the floor drain set into a sink or above the toilet either with bare hands or using a tool for cleaning. However, if the user picks the floor drain grate and the floor drain set up by hands, their hands inevitably come into contact with the residue, dirt, and mold thereon, resulting in an unsanitary impression. Even the tool is used to avoid direct hand contact, it is difficult to use the tool to pick up and hold a round-shaped drain trap core of the floor drain set with one hand and wash it with the other. Therefore, the entire cleaning process for the floor drain grate and the floor drain set requires different tools, and is quite inconvenient. Thus, there is room for improvement.

### SUMMARY

Therefore, an object of the disclosure is to provide a pick-up tool for picking up a floor drain assembly that can alleviate at least one of the drawbacks of the prior art.

According to the disclosure, the pick-up tool includes a main body. The main body is integrally formed and has a stationary portion, two operation portions, two hook portions, and an auxiliary portion. The stationary portion is plate-shaped and has a top end and a bottom end opposite to each other. Each of the operation portions is plate-shaped, and has a top edge and a bottom edge that are opposite to each other, and a connection region that interconnects the top edge and the bottom edge. The top edges of the operation portions and the bottom end of the stationary portion are connected to each other. For each of the operation portions, the connection region extends from the top edge in a direction away from the top end of the stationary portion and is spaced apart from the connection region of another one of the operation portions. Each of the hook portions is plate-shaped, and is connected to the bottom edge of a respective one of the operation portions. Each of the hook portions and the connection region of the respective one of the operation portions form an included angle therebetween. The auxiliary portion is configured as a thin plate and extends from the top end of the stationary portion in a direction away from the bottom end of the stationary portion. The auxiliary portion has a thickness that gradually decreases in the direction away from the bottom end.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1A is a perspective view illustrating a first embodiment of a pick-up tool for picking up a floor drain assembly according to the disclosure.

FIG. 1B is a front view of the first embodiment.

FIG. 1C is a side view of the embodiment.

FIG. 2 is an exploded perspective view of a floor drain assembly.

FIG. 3 is a perspective view illustrating a second embodiment of the pick-up tool according to the disclosure.

FIG. 4 is a perspective view illustrating an engagement portion of the second embodiment hooking a drainage hole of a drain cover.

FIG. 5 is a perspective view illustrating recess grooves of two hook portions of the second embodiment engaging a head portion of an interception piece.

FIG. 6 is a perspective view illustrating the second embodiment picking up a drain trap core.

FIG. 7 is a perspective view illustrating a third embodiment of the pick-up tool according to the disclosure.

FIG. 8 is a perspective view illustrating a fourth embodiment of the pick-up tool according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

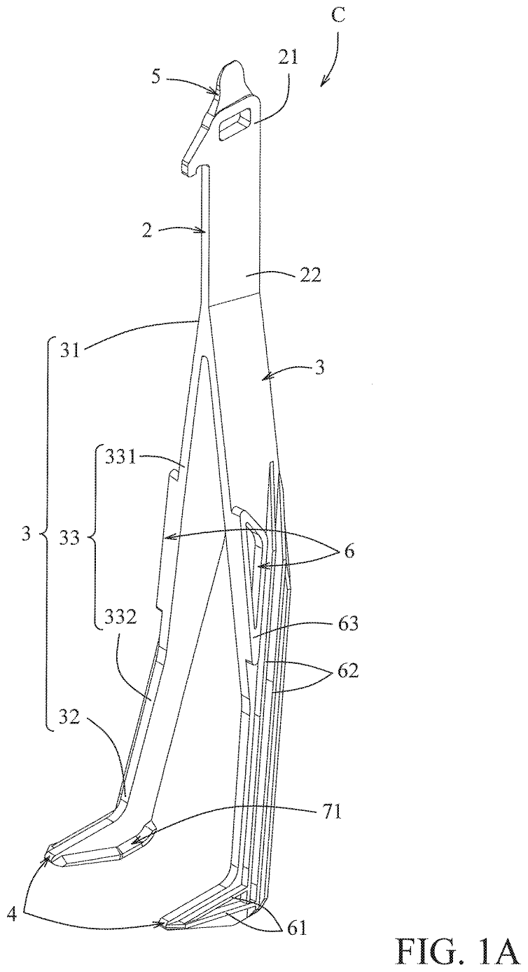

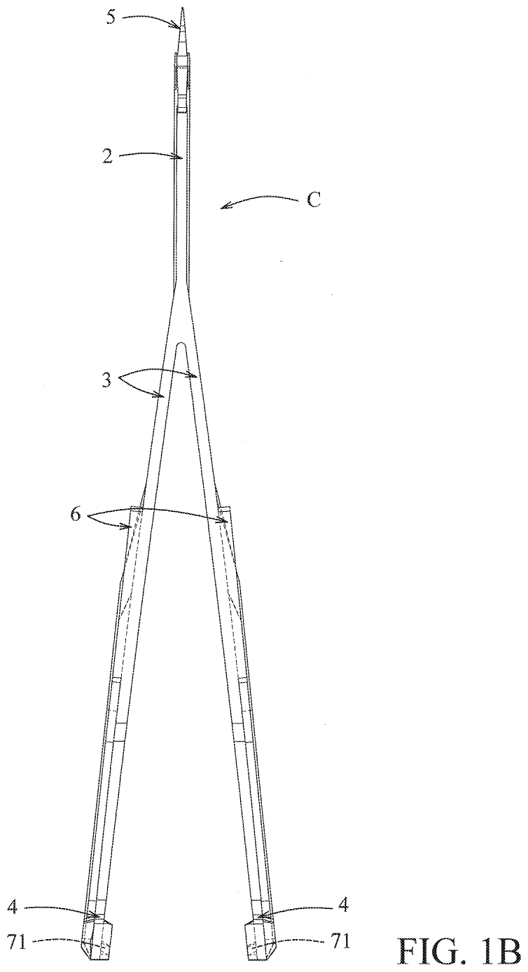

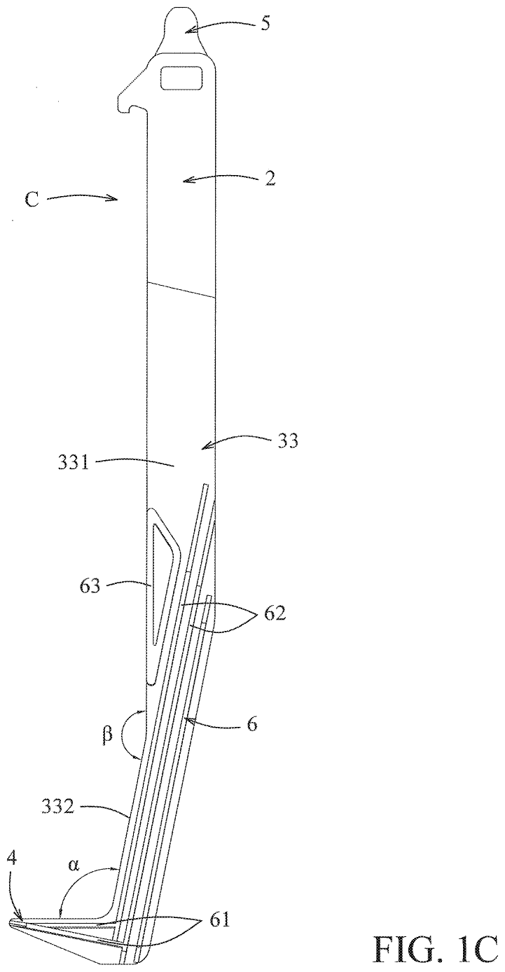

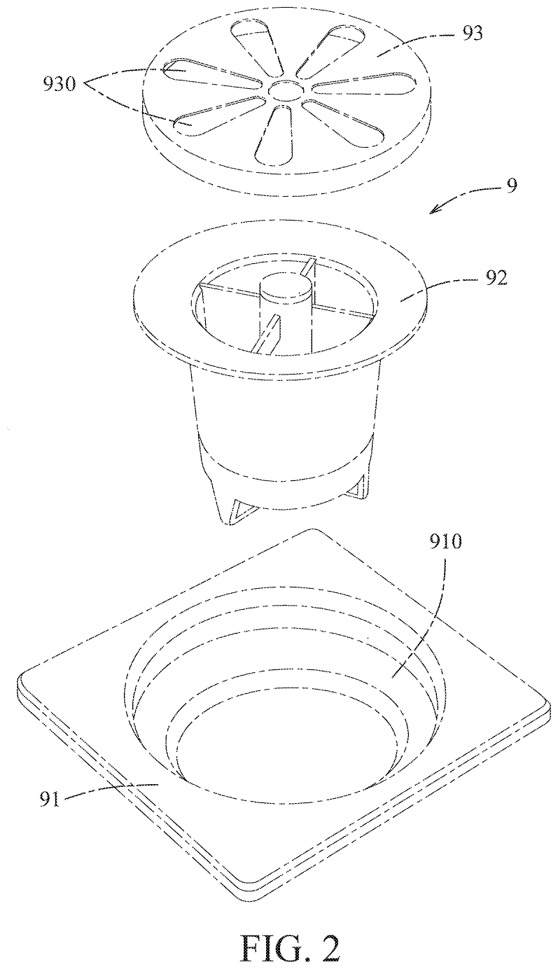

Referring to FIGS. 1A to 1C, a first embodiment of a pick-up tool for picking up a floor drain assembly 9 (see FIG. 2) is shown. The floor drain assembly 9 includes a base seat 91 that has a stepped bore 910 and that is mounted in the ground (not shown), a drain main body 92 that is mounted in the stepped bore 910 of the base seat 91, and a metal drain cover 93 that covers the drain main body 92 and the stepped bore 910 and that has multiple perforations 930. The first embodiment includes a main body (C) that is integrally formed by injection molding and that is made of a plastic material. The main body (C) has a stationary portion 2, two operation portions 3, two hook portions 4 and an auxiliary portion 5.

The stationary portion 2 is plate-shaped and has a top end 21 and a bottom end 22 opposite to each other.

Each of the operation portions 3 is plate-shaped, and has a top edge 31 and a bottom edge 32 that are opposite to each other, and a connection region 33 that interconnects the top edge 31 and the bottom edge 32. The top edges 31 of the operation portions 3 and the bottom end 22 of the stationary portion 2 are connected to each other. For each of the operation portions 3, the connection region 33 extends from the top edge 31 in a direction away from the top end 21 of the stationary portion 2 and is spaced apart from the connection region 33 of another one of the operation portions 3.

Each of the hook portions 4 is plate-shaped, and is connected to the bottom edge 32 of a respective one of the operation portions 3. Each of the hook portions 4 and the connection region 33 of the respective one of the operation portions 3 form an included angle (α) therebetween.

The auxiliary portion 5 is configured as a thin plate and extends from the top end 21 of the stationary portion 2 in a direction away from the bottom end 22 of the stationary portion 2. The auxiliary portion 5 has a thickness that gradually decreases in the direction away from the bottom end 22.

When a user is to clean off debris and dirt (not shown) left on the metal drain cover 93 and in the drain main body 92, the hook portions 4 of the first embodiment are first placed into one of the perforations 930 of the metal drain cover 93 to hook and lift the metal drain cover 93 up, and then the metal drain cover 93 is placed into a sink or above a toilet (not shown) to be washed. Next, the auxiliary portion 5 of the first embodiment is inserted into a slit between a top portion of the drain main body 92 and a portion of the stepped bore 910 to detach the drain main body 92 from the stepped bore 910, and then the drain main body 92 is grabbed or hooked by the hook portions 4 and moved into the sink or above the toilet to be washed.

The connection region 33 of each of the operation portions 3 has a top segment 331 and a bottom segment 332 that are connected to each other, and that form an obtuse angle (β) therebetween. For each of the operation portions 3, the included angle (α) is smaller than the obtuse angle (β). Thus, the user may easily place the hook portions 4 into the one of the perforations 930 to hook and lift the metal drain cover 93 up without excessively adjusting an angle of the hook portions 4 as they are placed into the perforation 930, which is convenient for use.

Moreover, in order to effectively grab the drain main body 92, the main body (C) further has two reinforcement rib units 6 and two contact ribs 71. Specifically, each of the reinforcement rib units 6 is disposed on a respective one of the operation portions 3 and a respective one of the hook portions 4. The reinforcement rib units 6 protrude, in opposite directions, respectively from outer surfaces of the operation portions 3 that are opposite to each other and respectively from outer surfaces of the hook portions 4 that are opposite to each other. Each of the reinforcement rib units 6 has two first ribs 61, multiple second ribs 62 and a third rib 63. For each of the reinforcement rib units 6, the first ribs 61 are connected to each other at an end of the respective one of the hook portions 4 that is away from the respective one of the operation portions 3, and extend towards the respective one of the operation portions 3 respectively in two different directions. For each of the reinforcement rib units 6, the second ribs 62 are spaced apart from each other, and extend from a portion of the respective one of the operation portions 3 that is adjacent to a junction of the top segment 331 and the bottom segment 332 to the respective one of the hook portions 4. At least a portion of the second ribs 62 is connected to the first ribs 61. For each of the reinforcement rib units 6, the third rib 63 has a loop shape, is located on the respective one of the operation portions 3, is adjacent to the junction of the top segment 331 and the bottom segment 332 of the respective one of the operation portions 3 and is spaced apart from the second ribs 62. The contact ribs 71 are respectively located on the hook portions 4, and protrude towards each other respectively from bottom portions of inner surfaces of the hook portions 4 that face each other. By virtue of the configuration of the reinforcement rib units 6, stiffness of the operation portions 3 is improved, and by virtue of the configuration of the contact ribs 71, a contact area between the drain main body 92 and the embodiment is increased, which is more convenient for the user to grab the drain main body 92.

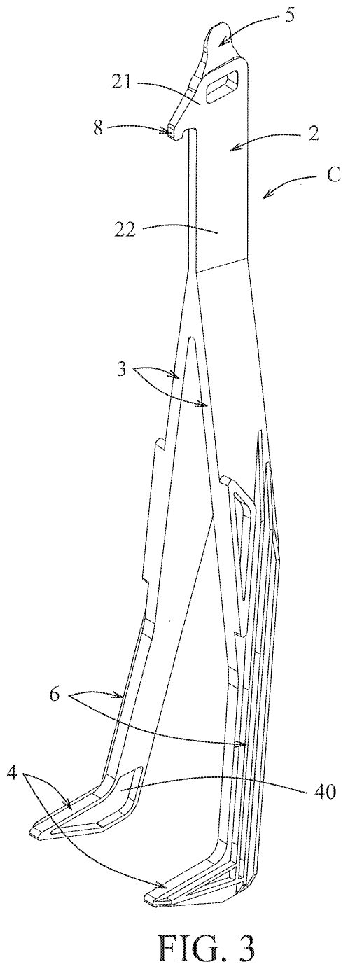

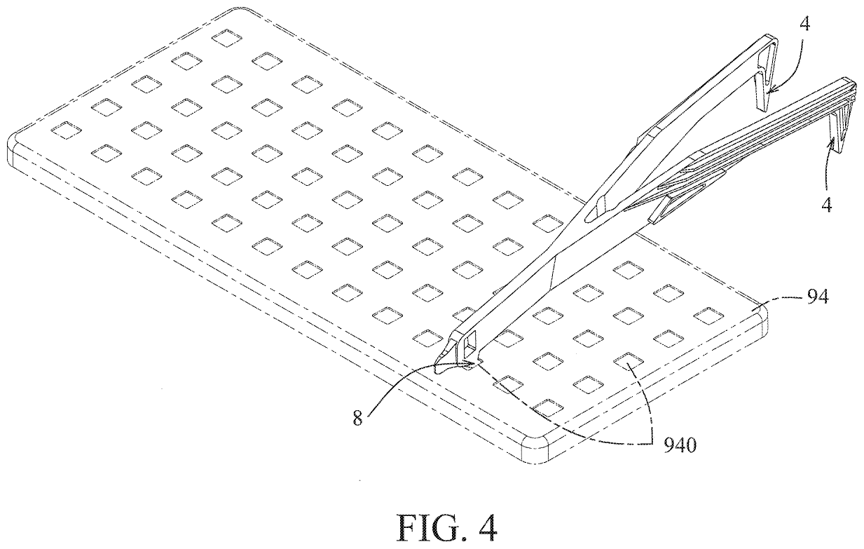

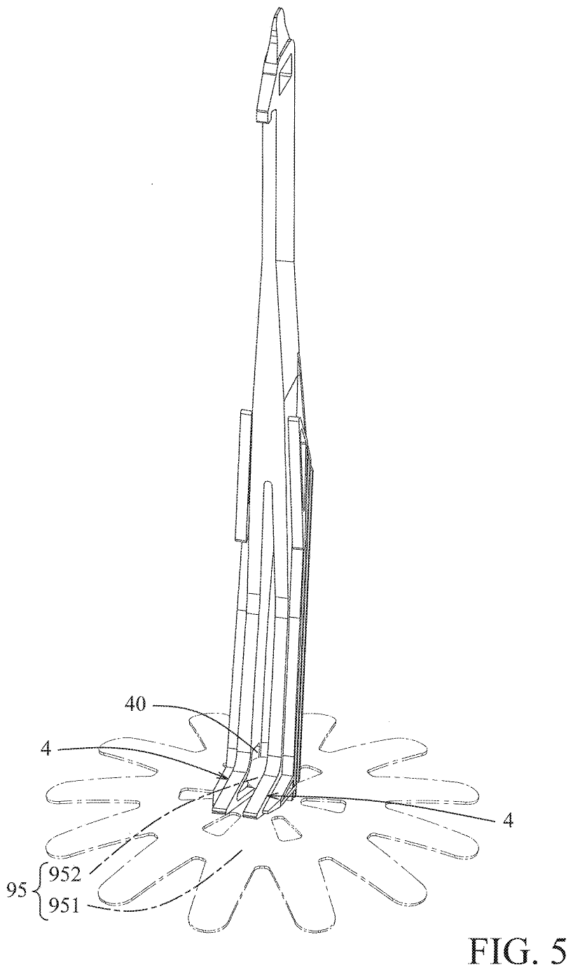

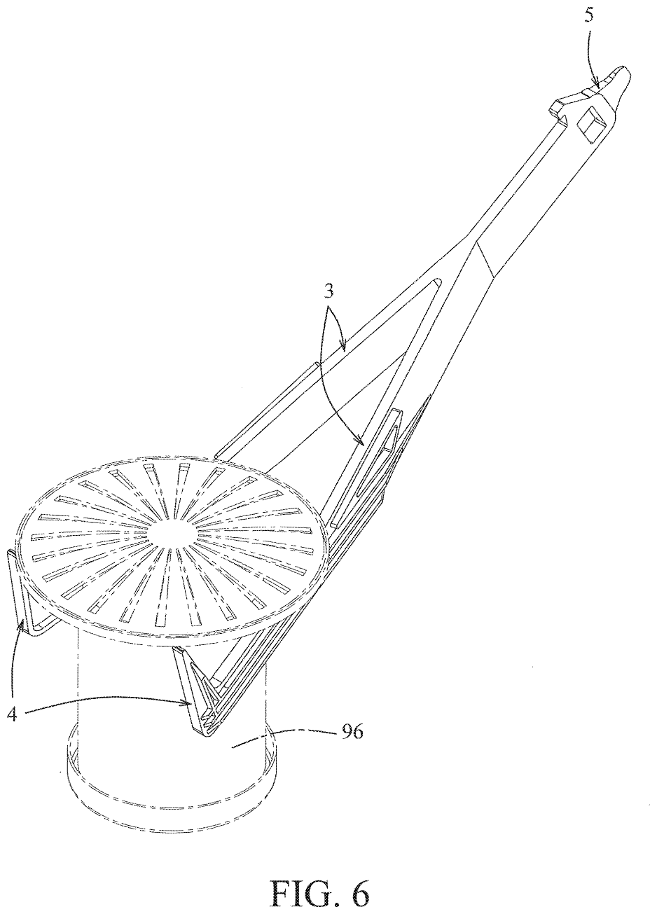

Referring to FIG. 3, a second embodiment of the pick-up tool is similar to the first embodiment, and differences therebetween lie in that a thickness of each of the hook portions 4 of the second embodiment is greater than that of each of the hook portions 4 of the first embodiment, and each of the hook portions 4 of the second embodiment has a recess groove 40 that is formed in an inner surface of the hook portion 4 facing another one of the hook portions 4, and that is recessed towards an outer surface of the hook portion 4 facing away from another one of the the hook portions 4. Besides, the main body (C) of the second embodiment further has an engagement portion 8. The engagement portion 8 is hook-shaped and plate-shaped, and extends from the top end 21 of the stationary portion 2 and bends towards the hook portions 4. By virtue of the structural design of the second embodiment, when the the user is grabbing the drain main body 92 with required grip strength, a contact area between the drain main body 92 and the second embodiment is increased. Specifically, the contact area between the drain main body 92 and the hook portions 4 or between the hook portions 4 and a head portion 952 of an interception piece 95 of the floor drain assembly 9 (see FIG. 5) is relatively great; moreover, the hook portions 4 and the operation portions 3 are able to pick up and hold the drain main body 92 having greater weight or a drain trap core 96 of the floor drain assembly 9 made of stainless steel (see FIG. 6), and the engagement portion 8 is able to hook and lift up a rectangular drain cover 94 having multiple apertures 940 that have relatively short widths (see FIG. 4). In some embodiments, the interception piece 95 may be made of a plastic or metal material, but is not limited thereto.

Referring to FIG. 4, the rectangular drain cover 94 may be mounted in an inlet of a drain pipe (not shown). In one example where the hook portions 4 of the second embodiment cannot be placed into the apertures 940, the user can use the engagement portion 8 instead and place the engagement portion 8 into one of the apertures 940 to remove the rectangular drain cover 94 from the inlet of the drain pipe.

Referring to FIG. 5, the interception piece 95 may be disposed between the metal drain cover 93 and the drain main body 92 (see FIG. 2). The interception piece 95 has the head portion 952 and further has a piece body portion 951 that extends radially. The head portion 952 protrudes upwards from a center portion of the piece body portion 951. During use, the user can use the recess grooves 40 of the hook portions 4 to engage and hold the head portion 952 of the interception piece 95, and then move the interception piece 95 into the sink or above the toilet to wash the same.

Referring to FIG. 6, the drain trap core 96 may be mounted in the stepped bore 910 of the base seat 91 to replace the drain main body 92. The drain trap core 96 is made of stainless steel and has greater weight than the drain main body 92. When the drain trap core 96 is to be cleaned, the auxiliary portion 5 is inserted into a slit between a top portion of the drain trap core 96 and a portion of the stepped bore 910 to detach the drain trap core 96 from the stepped bore 910, and then through the triangular supporting structure formed by the hook portions 4, the operation portions 3 and the drain trap core 96 (i.e., one of the operation portions 3 and the respective one of the hook portions 4 cooperatively support one side of the drain trap core 96, and another one of the operation portions 3 and the respective one of the hook portions 4 cooperatively support another side of the drain trap core 96), the pick-up tool may hook, pick up and move the drain trap core 96 into the sink or above the toilet for washing. Accordingly, the user does not have to worry about the hook portions 4 being too weak to pick up the drain trap core 96 having greater weight, and to bear the impact force of the water jet, and the effect of avoiding direct hand contact is achieved.

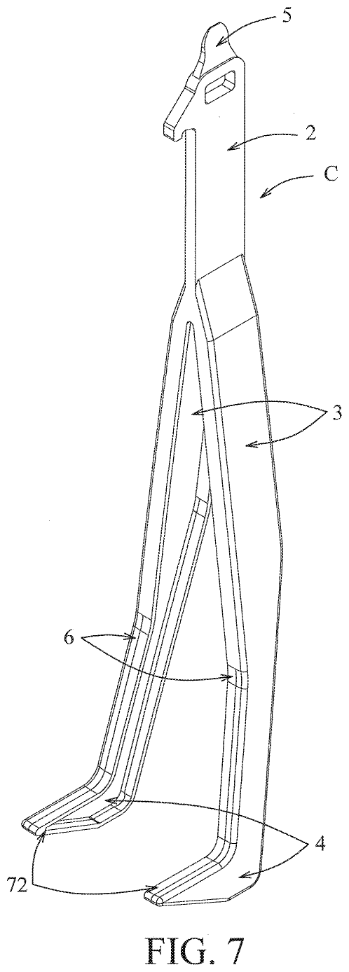

Referring to FIG. 7, a third embodiment of the pick-up tool is similar to the first embodiment, and differences therebetween lie in that the reinforcement rib units 6 are configured at a different position, the main body (C) of the third embodiment further has two contact rib sets 72 to replace the contact ribs 71 of the first embodiment, a thickness of each of the operation portions 3 of the third embodiment is smaller than a thickness of each of the operation portions 3 of the first embodiment, and a thickness of each of the hook portions 4 of the third embodiment is smaller than a thickness of each of the hook portions 4 of the first embodiment. Specifically, the contact rib sets 72 are respectively connected to the reinforcement rib units 6. Each of the reinforcement rib units 6 is disposed on a respective one of the operation portions 3, and protrudes, towards another one of the reinforcement rib units 6, from opposite edges of an inner surface of the respective one of the operation portions 3. The inner surfaces of the operation portions 3 face each other. Each of the contact rib sets 72 is disposed on a respective one of the hook portions 4, and protrudes, towards another one of the contact rib sets 72, from opposite edges of an inner surface of the respective one of the hook portions 4. The inner surfaces of the hook portions 4 face each other. By virtue of the structural design of the third embodiment, when the user is grabbing the drain main body 92 with required grip strength, a contact area between the drain main body 92 and the third embodiment is increased. Specifically, the contact area between the drain main body 92 and the hook portions 4 or between the hook portions 4 and the head portion 952 (see FIG. 5) is relatively great.

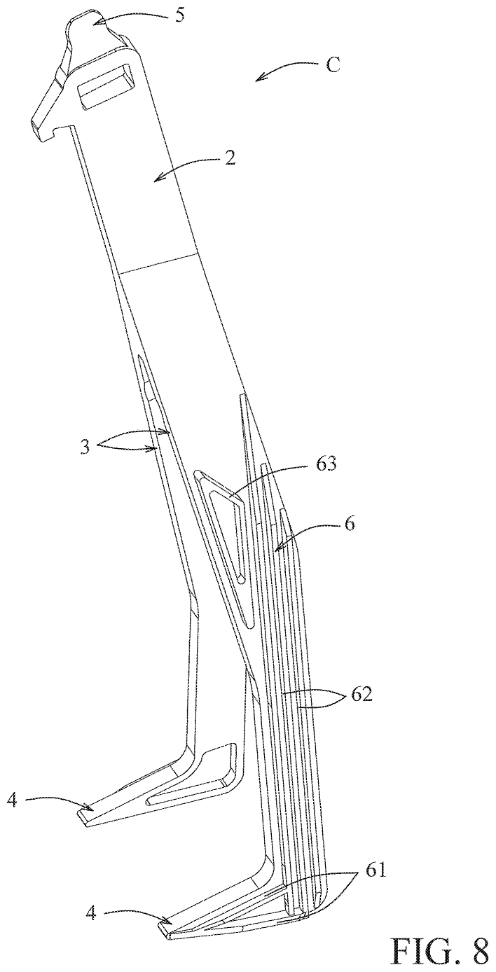

Referring to FIG. 8, a fourth embodiment of the pick-up tool is similar to the first and second embodiments, and a difference therebetween is the configuration of the reinforcement rib units 6. Specifically, in the fourth embodiment, for each of the reinforcement rib units 6, one of the first ribs 61 is located on a bottom edge of the respective one of the hook portions 4. It should be noted that the first ribs 61 make the collection of hairs (not shown) on the metal drain cover 93 and removal of dirt easy, and after the collection of hairs and dirt, the user can grab and throw away the hairs and dirt with the hook portions 4 of the pick-up tool, which has the effect of avoiding direct hand contact.

Moreover, in some examples, when the metal drain cover 93 is to be cleaned, the user may hook and lift the metal drain cover 93 up with the hook portions 4 and move them into the sink or above the toilet to wash them. In other examples, when the drain main body 92 (or the drain trap core 96) is to be cleaned, the auxiliary portion 5 is inserted into the slit between the top portion of the drain main body 92 (or the top portion of the drain trap core 96) and the portion of the stepped bore 910 to detach the drain main body 92 (or the drain trap core 96) from the stepped bore 910, and then the drain main body 92 is grabbed by the contact ribs 71 or the contact rib sets 72 located on the hook portions 4 and moved into the sink or above the toilet to be washed (or and then through the triangular supporting structure formed by the hook portions 4, the operation portions 3 and the drain trap core 96, the pick-up tool may hook, pick up and move the drain trap core 96 into the sink or above the toilet for washing). In one example, the user can place the engagement portion 8 into one of the apertures 940 to remove the rectangular drain cover 94 from the inlet of the drain pipe. In another example, the user can use the recess grooves 40 of the hook portions 4 to engage and hold the head portion 952 of the interception piece 95, and then move the interception piece 95 into the sink or above the toilet to wash the same. Thus, compared to the prior art, when the floor drain assembly 9 is picked up and to be cleaned, other tools and direct hand contact are prevented, which is convenient and hygienic.

To sum up, in the disclosure, the user may hook and lift the metal drain cover 93 up with the hook portions 4, then the auxiliary portion 5 is inserted into the slit between the top portion of the drain main body 92 (or the top portion of the drain trap core 96) and the portion of the stepped bore 910 to detach the drain main body 92 (or the drain trap core 96) from the stepped bore 910, and the drain main body 92 is grabbed by the contact ribs 71 or the contact rib sets 72 located on the hook portions 4 (or and through the triangular supporting structure formed by the hook portions 4, the operation portions 3 and the drain trap core 96, the pick-up tool may hook and hold the drain trap core 96). The user can use the recess grooves 40 of the hook portions 4 to engage and hold the head portion 952 of the interception piece 95. The first ribs 61 make the collection of hairs (not shown) on the metal drain cover 93 and removal of dirt easy, and after the collection of hairs and dirt, the user can grab and throw away the hairs and dirt with the hook portions 4 of the pick-up tool, which has the effect of avoiding direct hand contact without using other tools, achieving the object of the disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A pick-up tool for picking up a floor drain assembly, comprising:
a main body integrally formed and having:
a stationary portion that is plate-shaped and that has a top end and a bottom end opposite to each other;
two operation portions, each of said operation portions being plate-shaped, and having a top edge and a bottom edge that are opposite to each other, and a connection region that interconnects said top edge and said bottom edge, said top edges of said operation portions and said bottom end of said stationary portion being connected to each other, for each of said operation portions, said connection region extending from said top edge in a direction away from said top end of said stationary portion and being spaced apart from said connection region of another one of said operation portions;
two hook portions, each of said hook portions being plate-shaped, and being connected to said bottom edge of a respective one of said operation portions, each of said hook portions and said connection region of the respective one of said operation portions forming an included angle therebetween; and
an auxiliary portion that is configured as a thin plate and that extends from said top end of said stationary portion in a direction away from said bottom end of said stationary portion, said auxiliary portion having a thickness that gradually decreases in the direction away from said bottom end.

2. The pick-up tool as claimed in claim 1, wherein said connection region of each of said operation portions has a top segment and a bottom segment that are connected to each other, and that form an obtuse angle therebetween, for each of said operation portions, the included angle being smaller than the obtuse angle.

3. The pick-up tool as claimed in claim 2, wherein said main body further has two reinforcement rib units, each of said reinforcement rib units being disposed on a respective one of said operation portions and a respective one of said hook portions, said reinforcement rib units protruding, in opposite directions, respectively from outer surfaces of said operation portions that are opposite to each other and respectively from outer surfaces of said hook portions that are opposite to each other.

4. The pick-up tool as claimed in claim 3, wherein:
each of said reinforcement rib units has two first ribs, multiple second ribs and a third rib;
for each of said reinforcement rib units, said first ribs are connected to each other at an end of the respective one of said hook portions that is away from the respective one of said operation portions, and extend towards the respective one of said operation portions respectively in two different directions;
for each of said reinforcement rib units, said second ribs are spaced apart from each other, and extend from a portion of the respective one of said operation portions that is adjacent to a junction of said top segment and said bottom segment to the respective one of said hook portions, at least a portion of said second ribs being connected to said first ribs; and
for each of said reinforcement rib units, said third rib has a loop shape, is located on the respective one of said operation portions, is adjacent to said junction of said top segment and said bottom segment of the respective one of said operation portions and is spaced apart from said second ribs.

5. The pick-up tool as claimed in claim 4, wherein for each of said reinforcement rib units, one of said first ribs is located on a bottom edge of the respective one of said hook portions.

6. The pick-up tool as claimed in claim 3, wherein said main body further has two contact ribs, said contact ribs being respectively located on said hook portions, and protruding towards each other respectively from bottom portions of inner surfaces of said hook portions that face each other.

7. The pick-up tool as claimed in claim 3, wherein each of said hook portions has a recess groove that is formed in an inner surface of said hook portion facing another one of said hook portions, and that is recessed towards an outer surface of said hook portion facing away from another one of said hook portions.

8. The pick-up tool as claimed in claim 1, wherein said main body further has an engagement portion, said engagement portion being hook-shaped and plate-shaped, and extending from said top end of said stationary portion and bending towards said hook portions.

9. The pick-up tool as claimed in claim 1, wherein said main body further has two reinforcement rib units and two contact rib sets that are respectively connected to said reinforcement rib units, each of said reinforcement rib units being disposed on a respective one of said operation portions, and protruding, towards another one of said reinforcement rib units, from opposite edges of an inner surface of the respective one of said operation portions, said inner surfaces of said operation portions facing each other, each of said contact rib sets being disposed on a respective one of said hook portions, and protruding, towards another one of said contact rib sets, from opposite edges of an inner surface of the respective one of said hook portions, said inner surfaces of said hook portions facing each other.

10. The pick-up tool as claimed in claim 1, wherein said main body is integrally formed by injection molding.

11. The pick-up tool as claimed in claim 1, wherein said main body is made of a plastic material.
